(19) United States
(12) Patent Application Publication
(10) Pub. No.: US 2004/0067037 A1
(43) Pub. Date: Apr. 8, 2004

(54) Curing of compositions for fiber optics

(75) Inventors: Mark J. Tausch, West Chester, OH (US); Dennis J. Losco, Easton, PA (US); Jeffry W. Losco, Phillipsburg, NJ (US)

Correspondence Address: WOOD, HERRON & EVANS, LLP, 2700 CAREW TOWER, 441 VINE STREET, CINCINNATI, OH, 45202, US

(73) Assignees: Delaware Capital Formation, Inc., Wilmington, DE (US); Superior Quartz Products, Inc., Phillipsburg, NJ (US)

(21) Appl. No.: 10/263,537

(22) Filed: Oct. 3, 2002

(51) Int. Cl. B05D 5/06; B05D 3/06

(52) U.S. Cl. 385/141; 427/558; 427/487; 427/163.2

(57) ABSTRACT

A system and method for curing compositions on optical fibers. A UV curing cassette is provided with an elongate tube through which the optical fiber is drawn. A pair of medium pressure arc lamps are positioned on diametrically opposite sides of the tube and a pair of reflectors are positioned around the respective arc lamps. A stepless power supply is connected to the arc lamps to drive the lamps, thereby generating ultraviolet light. The arc lamps are selected and adjusted, if necessary, to produce a wavelength output that substantially correlates with at least one wavelength range of the absorbency spectrum of the photoinitiator in the composition to be cured. By this system and method, UV curable compositions may be cured to a high curing percentage at quick draw speeds to produce optical fibers of strong but flexible fiber quality.

### CROSS REFERENCE TO RELATED APPLICATION

This application is related to commonly-owned provisional U.S. Patent Application Serial No. 60/227,704 filed Aug. 24, 2000, now abandoned, entitled “Curing of Fiber Optic Coatings” hereby incorporated by reference herein in its entirety.

### BACKGROUND OF THE INVENTION

This invention relates generally to the curing of compositions used for the manufacture of optical fibers and fiber cables, and more specifically to the UV light curing of coatings, inks and adhesives on optical fibers and fiber cables and the high speed and consistent curing of those compositions.

In the past, the technology of the ultraviolet (UV) curing of various inks and other similar substances has been known. This technology has also been applied to cure the coatings, inks and adhesives applied during the manufacture of optical fibers and fiber cables. Commonly, microwave-driven cassettes are employed for curing the compositions on optical fibers. These cassettes, however, only accommodate slow drawing speeds, and slow curing rates, which can result in incomplete curing and weak fiber quality.

There is thus a need for a system and method for curing compositions used in the manufacture of fiber optics that provides high draw speeds, high cure quality and strong but flexible fiber quality.

### SUMMARY OF THE INVENTION

The present invention provides a system for curing UV curable compositions applied to optical fibers that is flexible, accommodates quick draw speeds, and produces strong but fiber flexible quality. To this end, an elongate tube is provided through which an optical fiber may be drawn, the optical fiber having an uncured composition thereon that contains photoinitiator(s) for initiating polymerization. A UV curing cassette is provided having a pair of medium pressure arc lamps positioned on opposite sides of the tube and a pair of reflectors around the respective pair of arc lamps. A stepless power supply is connected to each of the arc lamps for driving the lamps to generate UV light, which is directed through the tube to the optical fiber. The wavelength outputs of the lamps substantially correlate with at least one wavelength range of an absorbency spectrum of the photoinitiator(s) in the composition to be cured, such that the light generated from the lamps is sufficient to initiate polymerization to thereby cure the composition.

The present invention further provides a method for curing a UV curable composition on an optical fiber. To this end, a UV curable composition containing one or more photoinitiators is applied to the optical fiber. The optical fiber is drawn through an elongate tube positioned in a UV curing cassette. The cassette includes the pair of medium pressure arc lamps positioned on opposite sides of the tube, the pair of reflectors positioned around the arc lamps, and the stepless power supply connected to the arc lamps. The arc lamps are driven by the power supply to generate the UV light having the wavelengths output that substantially correlates with at least one wavelength range of the absorbency spectrum of the photoinitiator(s). This light is directed through the tube onto the composition thereby curing the composition.

The system and method of the present invention may be used to cure coatings on optical fibers, to cure inks used for coloring optical fibers, or to cure adhesives used for manufacturing fiber cables.

### BRIEF DESCRIPTION OF THE DRAWINGS

The objectives and features of the invention will become more readily apparent from the following detailed description taken in conjunction with the accompanying drawings in which:

FIG. 1 is a schematic representation of the components of a wet-on-dry draw tower according to one exemplary embodiment of the present invention for curing the coatings on optical fibers;

FIG. 2 is a cross-sectional view of a cured optical fiber;

FIG. 3 is a side plan view of an optical fiber being drawn through a vertically-mounted cassette assembly according to one exemplary embodiment of the present invention;

FIG. 4 is a cross-sectional top view of the assembly of FIG. 3 showing the optical fiber being drawn through a tube between opposed UV curing lamps with associated reflectors;

FIGS. 5-20 are absorbency spectra for photoinitiators that may be used in the compositions to be cured on optical fibers by the cassette assembly according to this invention;

FIGS. 5A-20A depict the chemical structures of the photoinitiators of FIGS. 5-20, either before or both before and after curing by the cassette assembly according to this invention;

FIG. 21 is a spectral radiometric plot for a standard medium pressure mercury arc lamp;

FIG. 22 is a spectral radiometric plot for a medium pressure mercury arc lamp having an increased intensity output at 308 nm in accordance with the present invention;

FIG. 23 is a spectral radiometric plot for a medium pressure mercury arc lamp having an increased intensity output below 300 nm in accordance with the present invention;

FIG. 24 is a spectral radiometric plot for a standard gallium metal halide arc lamp; and

FIG. 25 is a spectral radiometric plot for a standard iron metal halide arc lamp.

### DESCRIPTION OF THE INVENTION

The present invention was initiated, designed, developed and successfully tested to include a UV cassette to cure the coatings, adhesives and inks applied to optical fibers. The cure results were determined to be as good or better than test results obtained from systems utilizing microwave-driven cassettes. To this end, a curing cassette is provided having a pair of medium pressure arc lamps, a pair of reflectors positioned around the lamps, and a stepless power supply driving the lamps to generate UV light having a wavelengths output that substantially correlates with at least one wavelength range of the absorbency spectrum of a photoinitiator(s) contained in the composition to be cured on the optical fiber. The compositions include those used for the primary and secondary coatings on optical fibers, the inks used for coloring optical fibers, and the adhesives used for manufacturing fiber cables comprising a plurality or bundle of optical fibers.

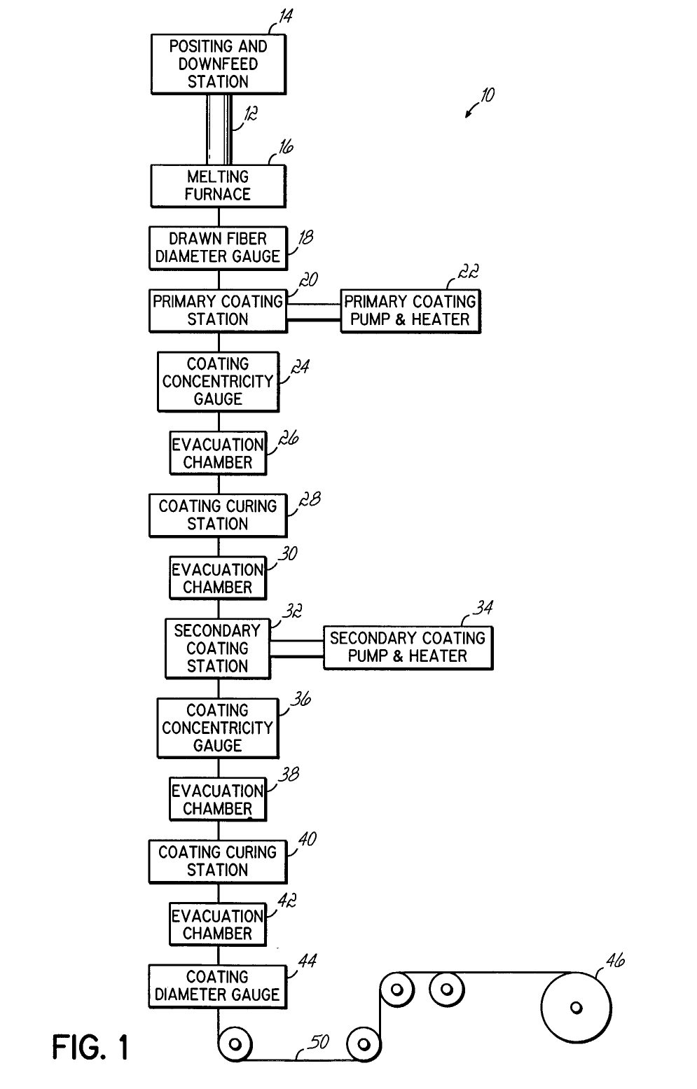

The invention can be best described in reference to the following drawings. In an exemplary embodiment of the present invention, a general wet-on-dry curing system 10 for coating optical fiber is depicted schematically in FIG. 1. In a wet-dry system, a primary coating is applied to the optical fiber and cured, and then a secondary coating is applied on the cured primary coating and then cured. In system 10, a quartz rod 12, which is used to form the core of the fiber, is positioned at positing and down-feed station 14 and fed to a melting furnace 16. Of course, other materials may be used for the core, such as plastic, and this invention is not to be limited to any particular core material. The core of the optical fiber is drawn from the furnace 16 utilizing drawn fiber diameter gauge 18 to control the core diameter. The optical fiber is then fed to a primary coating station 20 having an associated pump and heater 22 for effecting the primary coating. The coating is controlled by coating concentricity gauge 24 and the uncured primary coating is then fed through evacuation chamber 26 and into coating curing station 28, also referred to as a curing cassette. The cured optical fiber is again passed through an evacuation chamber 30 and into a secondary coating station 32 having an associated pump and heater 34 for effecting the secondary coating. The uncured secondary coating is controlled by a coating concentricity gauge 36 and the fiber is fed through an evacuation chamber 38 and into a second curing station or curing cassette 40. The double-coated cured optical fiber is again fed through an evacuation chamber 42 and the diameter controlled by a coating diameter gauge 44. The cured optical fiber 50 having the desired diameter is then fed to a take-up reel 46.

Another type of system 10 that can be used in the present invention is referred to as a wet-on-wet curing system. This type of system is essentially the same as the wet-on-dry curing system 10 depicted in FIG. 1, but eliminates the curing cassette 28 and evacuation chamber 30. Thus, in the wet-on-wet system, the primary coating is applied, then the secondary coating is applied onto the uncured primary coating. The uncured primary and secondary coatings are then passed through curing cassette 40 and simultaneously cured therein.

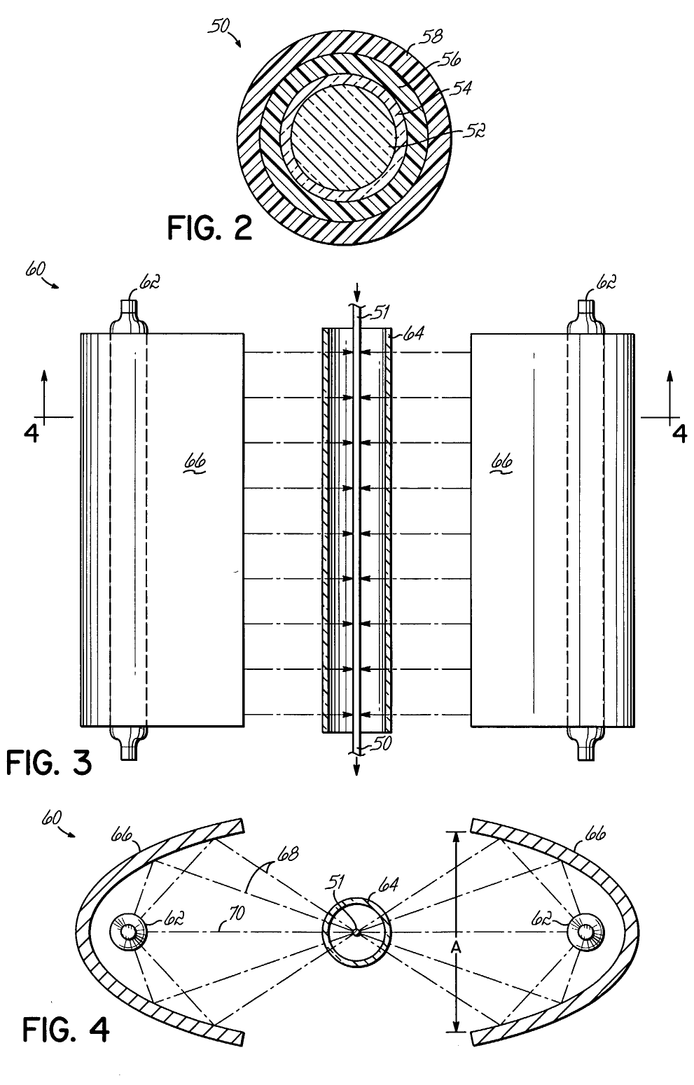

FIG. 2 depicts a cross-sectional view of a cured optical fiber 50, such as one produced by the draw tower device 10 of FIG. 1. The cured optical fiber 50 comprises core 52, such as a quartz core formed from the quartz rod 12 in device 10. A cladding layer 54 is created from the outer skin layer of core 52 by known processing techniques, which occur before the drawn fiber is fed to primary coating station 20 in device 10. The core 52 has a higher index of refraction than cladding layer 54, such that total internal reflection occurs. Primary coating 56 surrounds cladding layer 54. Primary coating 56 is generally a soft coating that provides the fiber 50 with flexibility. Secondary coating 58 surrounds primary coating 56, and generally comprises a hard coating material to provide the optical fiber 50 with abrasion resistance.

A schematic of an optical fiber curing cassette 60 according to an exemplary embodiment of this invention is shown in FIGS. 3 and 4. In system 10 of FIG. 1, cassette 60 may be used for curing cassettes 28 and 40. The UV curing cassettes according to this invention include arc lamps with a UV wavelength output that substantially correlates with at least one wavelength(s) absorbency of the absorbency spectrum or curve of the photoinitiators used in the composition to be cured. By substantially correlate, it is meant that the x-y curves of wavelength versus light intensity for the lamp output overlay the absorbency curves such that at one or more wavelengths there is correlation between intensity of the lamp and absorbency of the photoinitiator to initiate polymerization. While an exact match would be advantageous, it is only necessary that there be a close match or substantial correlation at the one or more wavelengths such that the UV light at those wavelengths adequately initiates the polymerization process. To state another way, there is substantial correlation where the magnitude of intensity of the lamp output and the magnitude of absorbence by the photoinitiator have values at a given wavelength or wavelength band such that polymerization is initiated in the composition.

Toward this end, the UV curing cassette 60 includes a pair of medium pressure arc lamps 62 positioned on diametrically opposite sides of a tube 64 through which an uncured optical fiber 51 is drawn. Tube 64 may be made of any high temperature material capable of transmitting UV light, for example quartz. A pair of reflectors 66 are positioned around the respective pair of arc lamps 62 to gather and direct ultraviolet light emitted from the arc lamps 62 toward the tube 64. As shown in FIG. 4, at least a portion 68 of the emitted light is reflected toward the tube 64, and a portion 70 may be emitted directly toward the tube 64 without first being reflected. A stepless power supply (not shown) is operably connected to each of the arc lamps 62 and are adapted to drive the lamps 62 to generate ultraviolet light for curing the optical fiber coating. According to an exemplary embodiment of this invention, UV curing cassette 60 includes a pair of focused elliptical reflectors 66 and a pair of 9 inch length arc lamps 62. The 9 inch length arc lamps 62 are suggested for use merely because microwave-driven cassettes formerly used contain 9 inch length lamps. The aperture dimension A shown in FIG. 4 may be 4.5 inches and the distance from the center line of each arc lamp 62 to the edge of the associated reflector 66 may be 2.29 inches in an exemplary embodiment. Arc lamps 62 may be medium pressure mercury, iron metal halide additive or gallium metal halide additive arc lamps, or any similar type of arc lamp now known or hereafter developed. For example, arc lamps 62 may be a pair of 25 mm diameter medium pressure mercury arc lamps, or may be 18 mm diameter medium pressure iron metal halide additive lamps. The draw rate of the optical fiber through the cassette is about 1000 to about 1500 meters per minute (m/min.) and may be as high as about 2000 m/min. or greater.

The stepless power supply that is utilized in an exemplary embodiment of this invention is generally described in U.S. Pat. No. 5,939,838, the disclosure of which is hereby incorporated by reference herein in its entirety. Such a power supply can be described as a stepless power supply to drive horizontally mounted medium pressure arc lamps. However, in the system of the present invention, the arc lamps may be vertically mounted, thereby providing increased flexibility for the manufacturing design. Because of the unique shape of the waveform output from this stepless power supply, significant increases in the UV output of the arc lamps utilized in this invention are obtained.

Spectral radiometric plots of the lamp intensity in mill Watts per square centimeter (mW/cm²) coupled to the stepless power supply showed the following: (1) a 15-20% increase in the UV output of a medium pressure mercury arc lamp; (2) a 70-80% increase in the UV output of a medium pressure gallium metal halide additive arc lamp; and (3) a 40-50% increase in the UV output of a medium pressure iron metal halide additive arc lamp.

The power supply according to this invention must be capable of driving a pair of 9 inch length arc, medium pressure small diameter lamps from 300 WPI to 700 WPI in a stepless manner. The pair of lamps are mounted either vertically or horizontally in the cassette 60 and on the draw tower 10. The power supply is also constructed such that it will drive the medium pressure mercury, iron metal halide additive and gallium metal halide additive arc lamps. To provide a reliable restart of the lamps after a discontinuation of operation, an ignitor circuit may be included.

However, the design of the igniter circuit and other modifications to the power supply do not impact the successful curing of the coatings on the optical fibers with the UV output of the cassette design according to this invention. Results of the testing of the curing of this system are shown in the following tables.

TABLE 1
Percent Residual Acrylate Unsaturated (% RAU) of secondary coating,
wherein the secondary coating was cured using a UV curing cassette
with a stepless power supply in accordance with the present invention
and the primary coating was cured using a microwave-driven UV
curing cassette in accordance with the prior art.

| Draw Speed | Applied Power | | |
|---|---|---|---|
| (m/min.) | (WPI) | % RAU | Fiber Quality |
| 60 | 450 | 99.95 | very brittle and weak |
| 90 | 450 | 99.95 | brittle and weak |
| 120 | 450 | 99.91 | brittle and weak |
| 175 | 450 | 99.95 | fairly strong |
| 175 | 300 | 87.97 | strong |

TABLE 2
Percent Residual Acrylate Unsaturated (% RAU) of secondary coating,
wherein both the primary and secondary coatings were cured using
microwave-driven UV curing cassettes in accordance with the prior art.

| Draw Speed | Applied Power | | |
|---|---|---|---|
| (m/min.) | (WPI) | % RAU | Fiber Quality |
| 34 | 400 | 87.15 | weak |

In Table 2, the general process for curing the primary and secondary coatings by microwave-driven UV curing cassettes was carried out at a typical draw speed of about 34 m/min. Approximately 87.15% curing was achieved, but the fiber quality was weak. When using a cassette in accordance with the present invention to cure the secondary coating, slow draw speeds and high applied power resulted in essentially complete curing of the secondary coating, but a generally brittle and weak fiber quality. By using a higher draw speed of 175 m/min. with lower power, fiber quality was improved. However, it is believed that even at a draw speed of 175 m/min., the coating is being cured too slowly, resulting in the brittle, weak nature of the fiber. High draw speeds, on the order of 1000 to 2000 m/min. at applied powers of 300-700 WPI are believed to provide complete curing with strong fiber quality.

While the above discussion and associated drawings have focused upon the curing of coating compositions on optical fibers, the present invention also applies to curing adhesives used for manufacturing fiber cables, which comprise a plurality of coated optical fibers bundled together, and for curing the inks used for coloring the optical fibers. In each of these applications, the composition to be cured comprises one or more photoinitiators. The photoinitiator(s) functions to initiate the polymerization process in the UV curable formulations used for coating compositions, inks and adhesives. The curable formulations may be based on any polymeric resin system, such as acrylate resins. Some photoinitiators available commercially from CIBA Specialty Chemicals include: Irgacure® 184, Irgacure® 369, Irgacure® 651, Irgacure® 819, Irgacure® 907, Irgacure® 1700, Irgacure® 1800, Irgacure® 1850, Darocur® 1173, and Darocur® 4265. Aldrich Polymer Products is one supplier of the photoinitiator benzophenone. Another photoinitiator, TZT, is a benzophenone methyl derivative of 2,4,6-trimethylbenzophenone and 4-methylbenzophenone. BASF provides a line of acylphosphine oxide photoinitiators under the trademark Lucirin®, for example Lucirin® TPO. Upjohn also supplies photoinitiators, such as DEAP, which is 2,2-diethoxyacetophenone. Octel Chemicals supplies such photoinitiators as Quantacure® EPD. More specifically, some exemplary photoinitiators useful in UV curable compositions in the system of the present invention include one or more of the following compounds: 1-hydroxycyclohexyl phenyl ketone; 2-benzyl-2-N,N-dimethylamino-1-(4-morpholinophenyl)-1-butanone; 2,2-dimethoxy-2-phenyl acetophenone; 2-methyl-1-[4-(methylthio)phenyl]-2-morpholino propan-1-one; 2-hydroxy-2-methyl-1-phenyl-propan-1-one; bis(2,6-dimethoxybenzoyl)-2,4,4-trimethylpentyl phosphine oxide; bis(2,4,6-trimethylbenzoyl)-phenylphosphineoxide; 2,4,6-trimethylbenzoyl diphenylphosphine oxide; benzophenone; 2,2-diethoxyacetophenone; 2,4,6-trimethylbenzophenone; 4-methylbenzophenone; ethyl 4-(dimethylamino) benzoate; isopropyl-2-thioxanthone; and isopropyl-4-thioxanthone.

One aspect of the present invention is the ability to coordinate the output of the arc lamps 62 with the spectral characteristics of the specific photoinitiators in the compositions to be cured. Exemplary coatings for optical fibers are commercially available from Borden Chemical, Inc., for example. The photoinitiators formulated into the coatings were identified in order to obtain the absorbency curves of the photoinitiators to help determine the appropriate wavelength output a UV curing lamp must provide to initiate polymerization. For the photoinitiator to initiate polymerization in the composition, photons must be absorbed. Thus, the lamp must generate photons at a wavelength that substantially corresponds to a wavelength at which the photoinitiator(s) will absorb photons. The greater the absorbency at a wavelength, the more photons the photoinitiator is capable of absorbing at that wavelength, and so the more photons generated by the lamp, the more efficient the polymerization will be. It may be understood that intensity and absorbency curves often exhibit peaks with decreasing absorbency and intensity at wavelengths around the peak. Thus, when referring to correlation at a wavelength, it is understood that correlation will exist with decreasing magnitude at wavelengths below and above the peak wavelength. In other words, there is correlation over a wavelength range that includes the peak wavelength. Correlation may also occur over a range of wavelength values for which there is a plateau for the intensity and/or absorbency with no clear peak wavelength. Thus, by wavelength range, Applicants refer to a span of wavelength values for which there is positive (non-zero) absorbence and/or intensity, regardless of whether a peak occurs. Thus, the present invention aims to utilize a lamp having high photon intensity within wavelength ranges that correspond to wavelength ranges at which the photoinitiator exhibits the ability to absorb those photons.

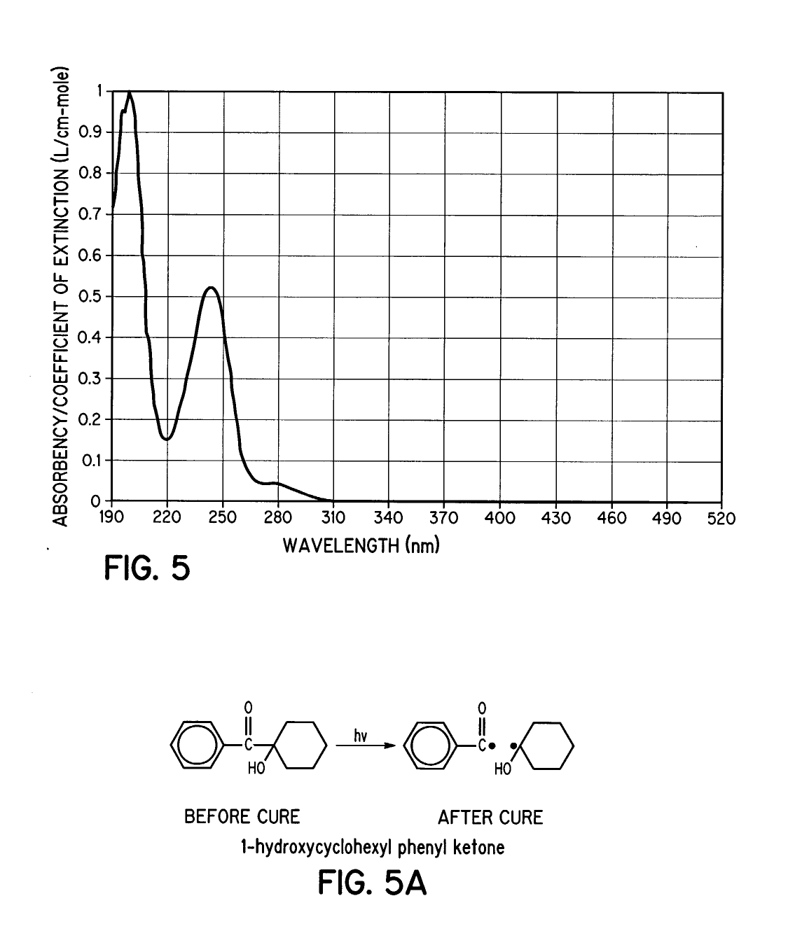

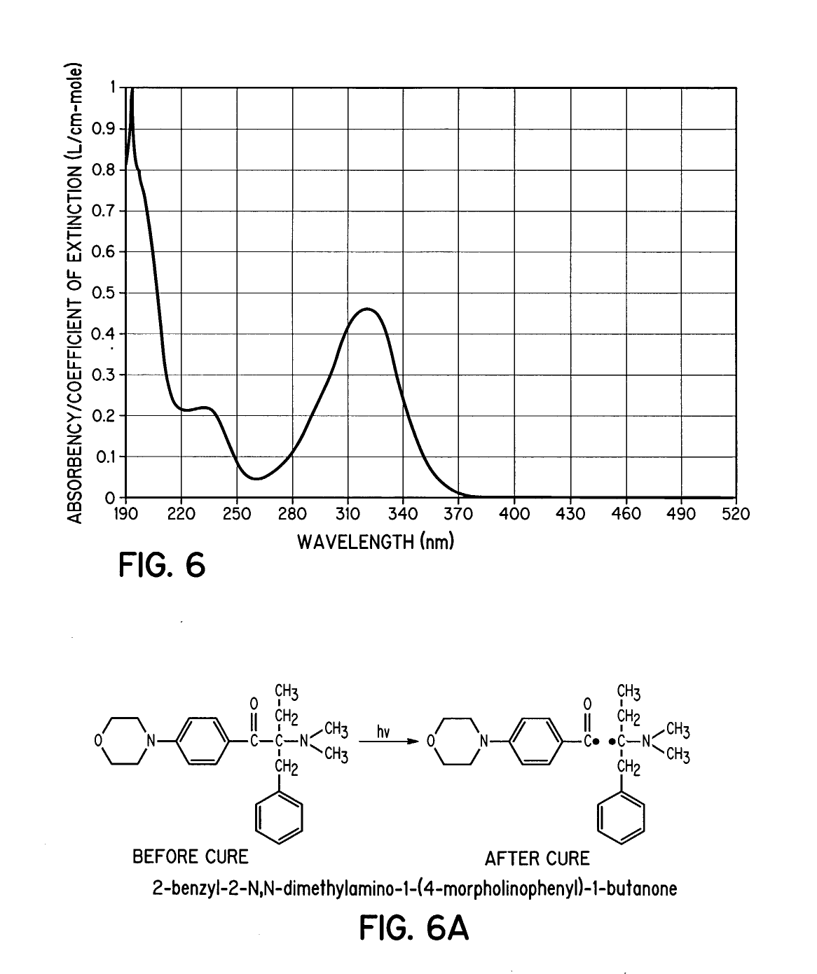

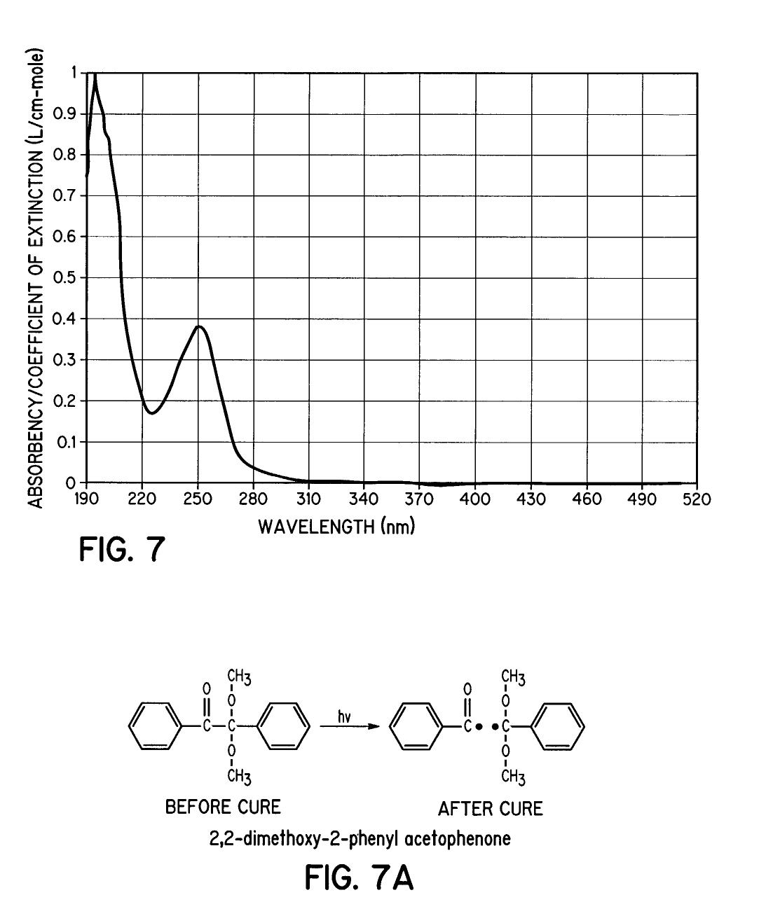

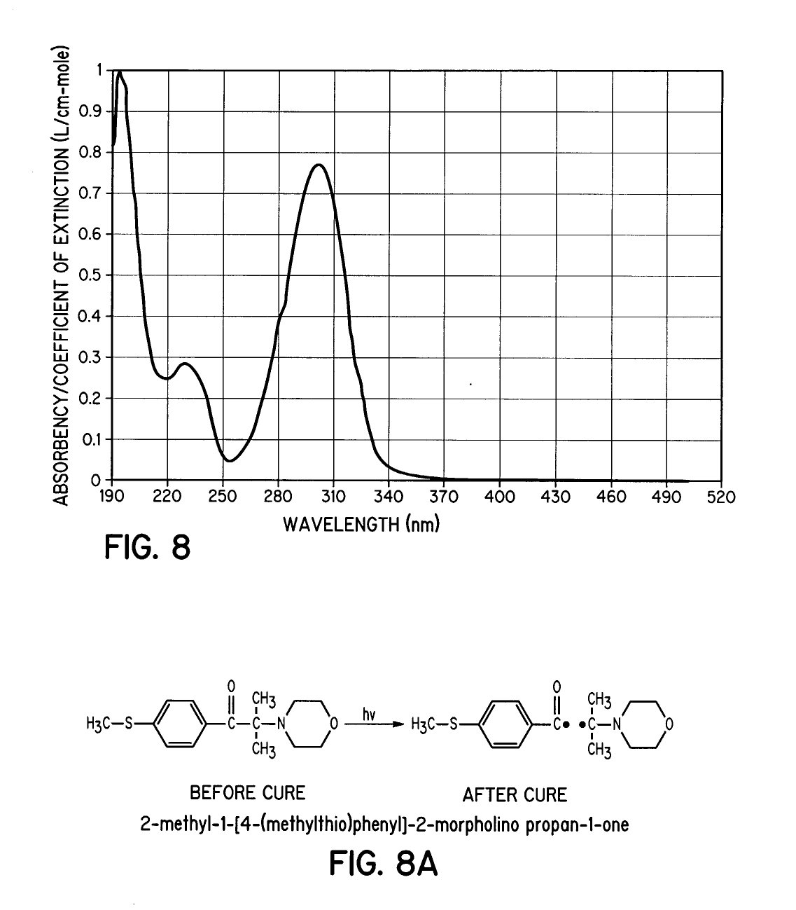

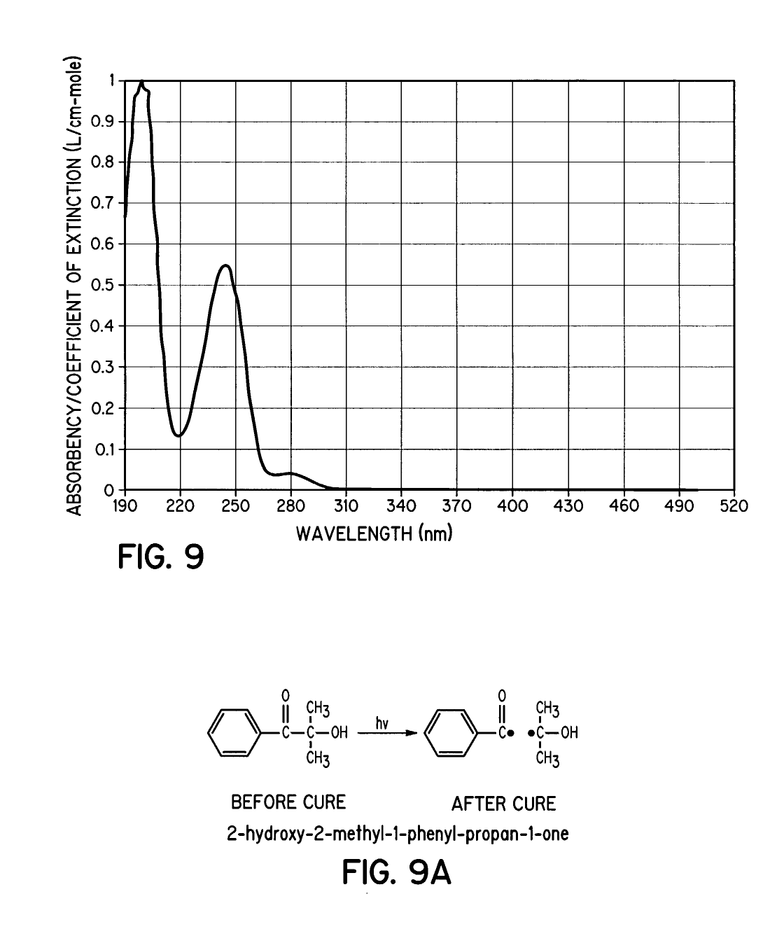

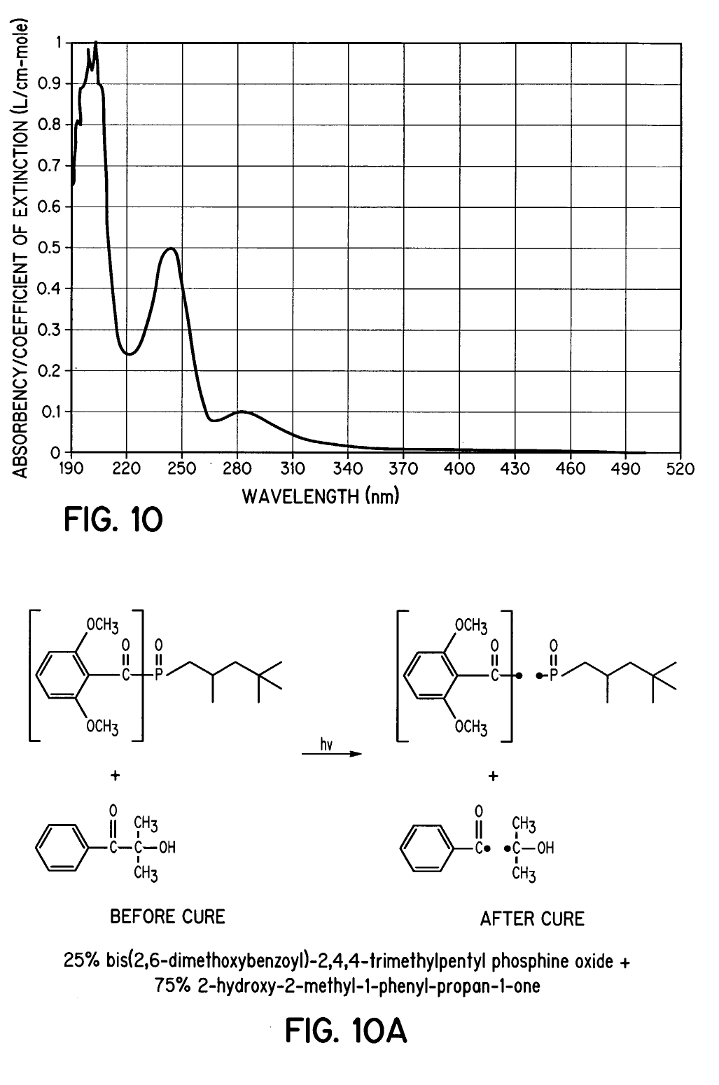

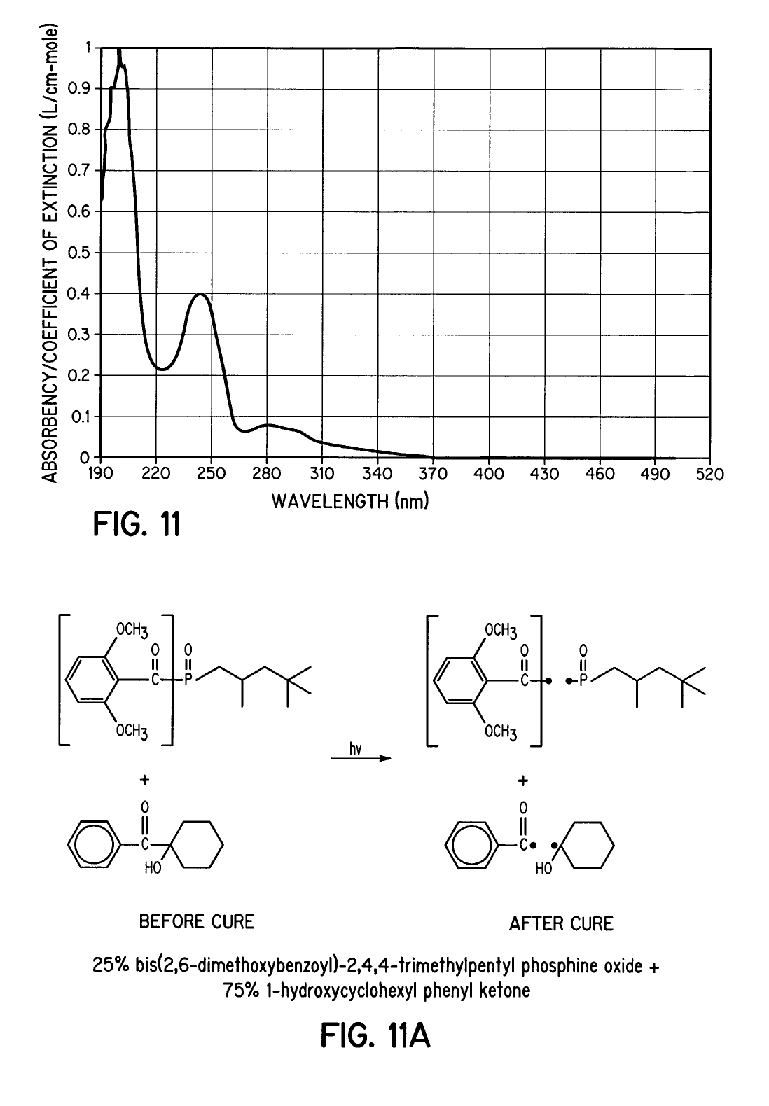

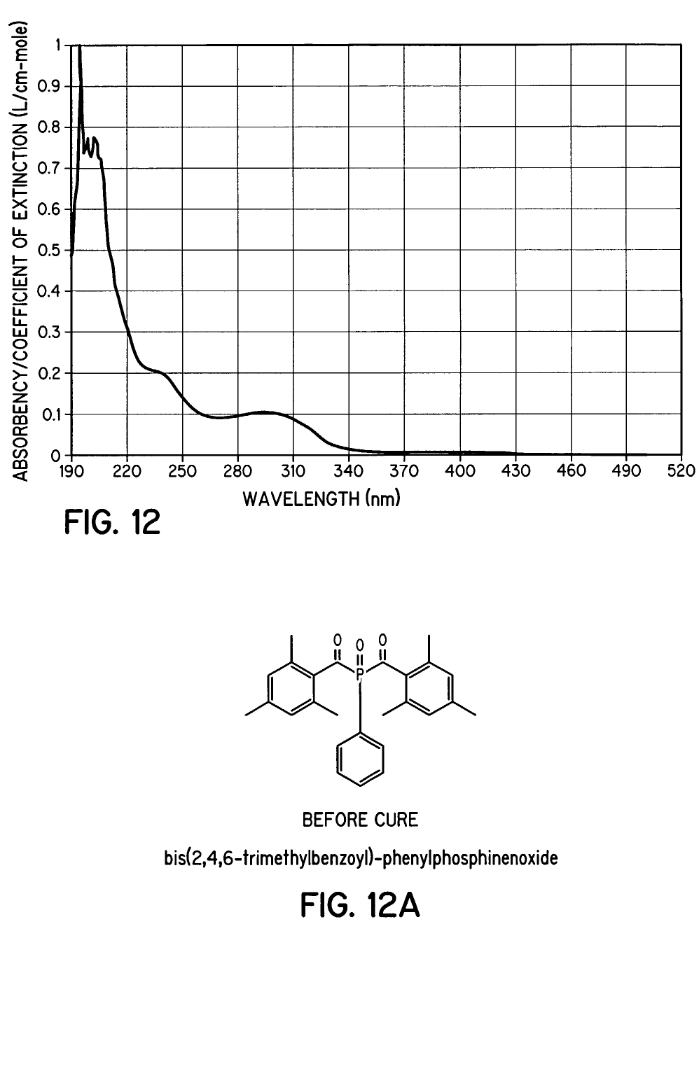

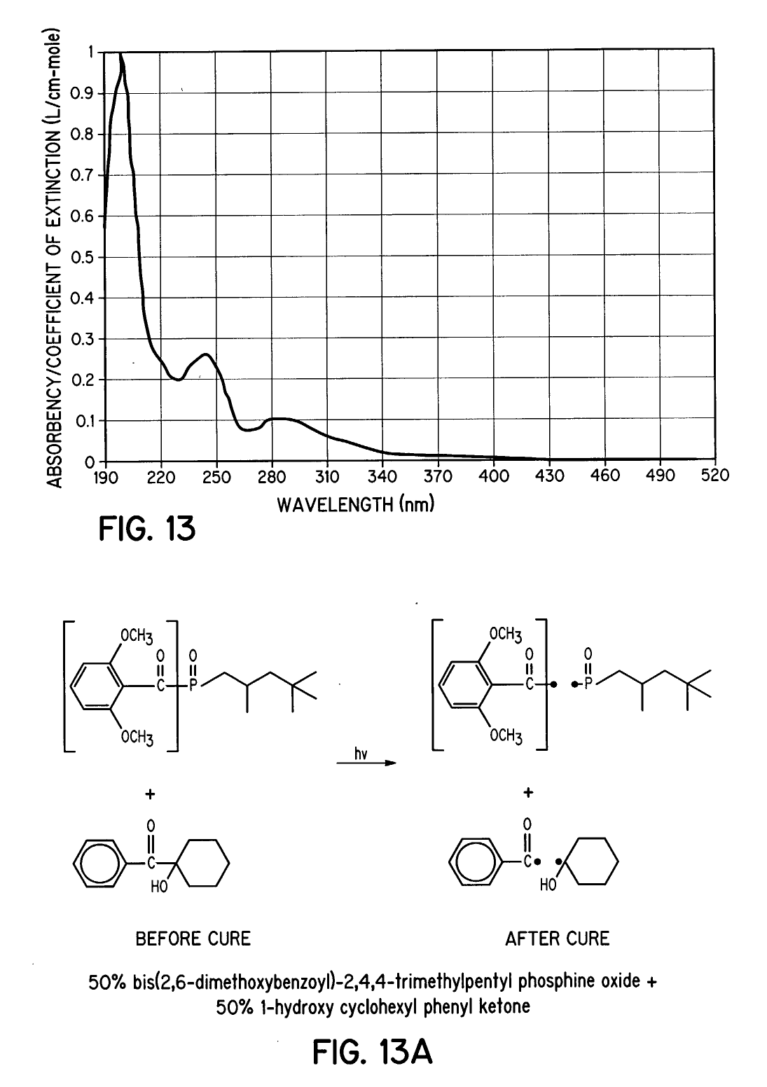

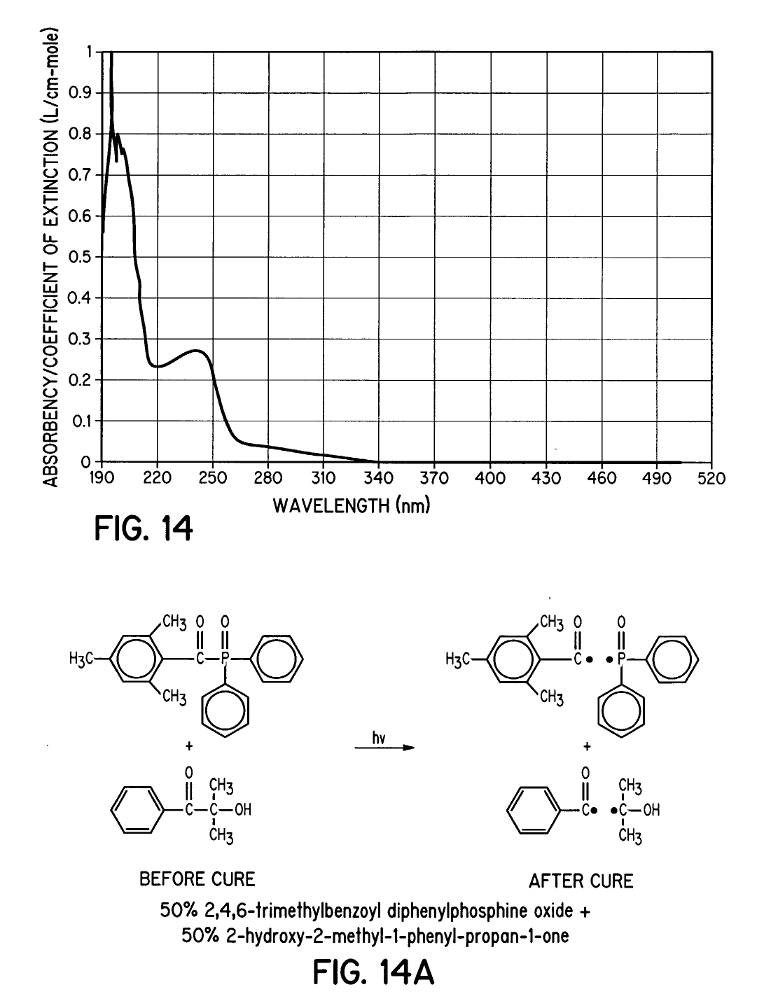

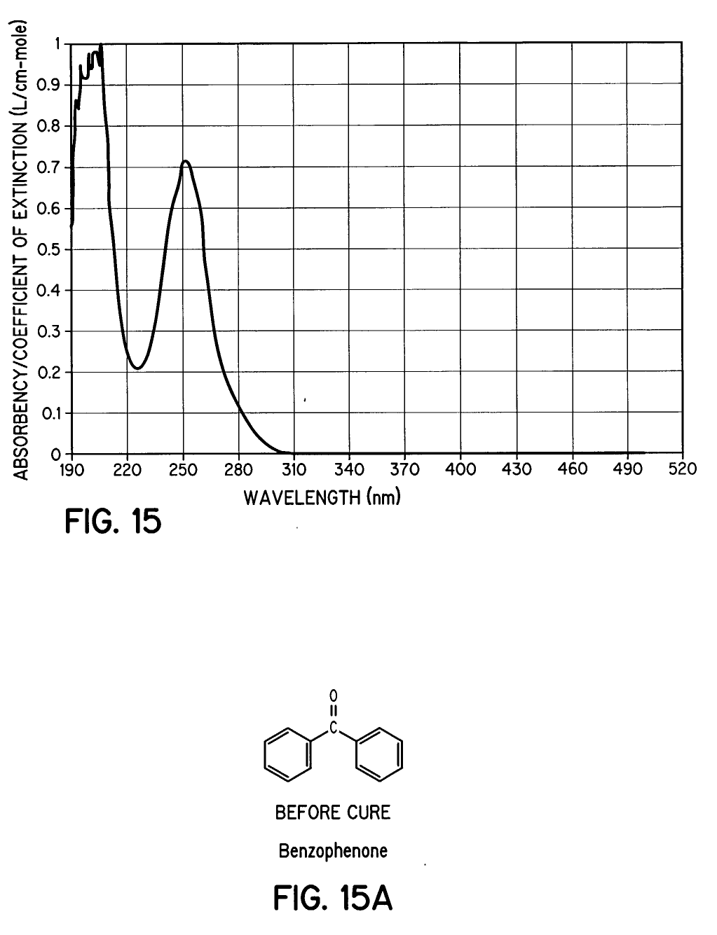

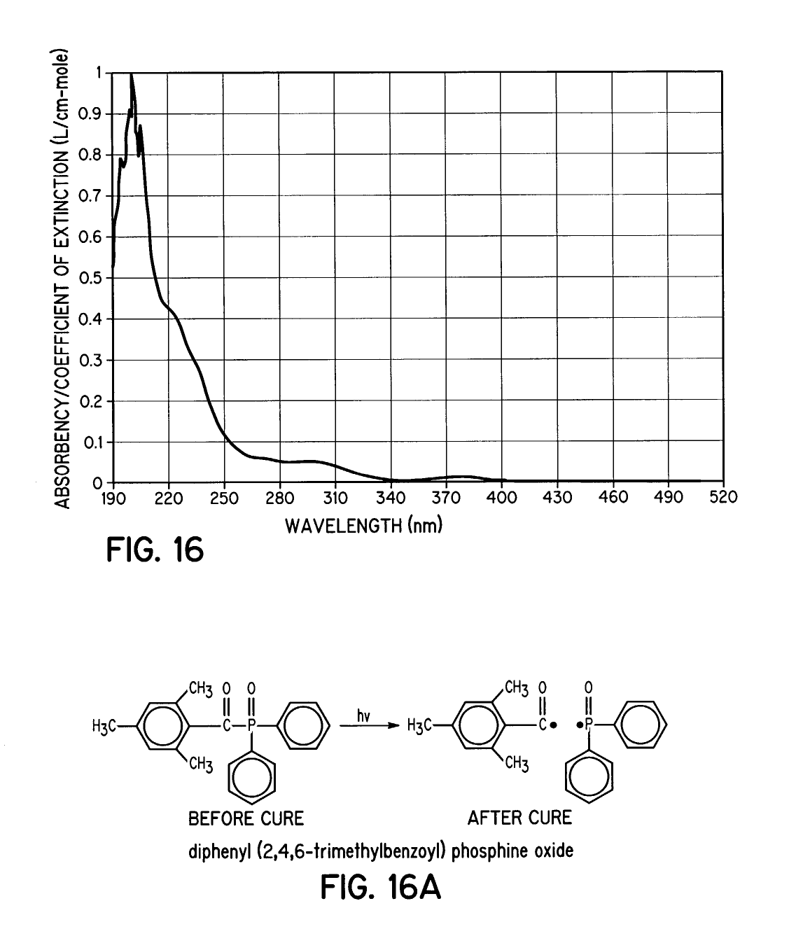

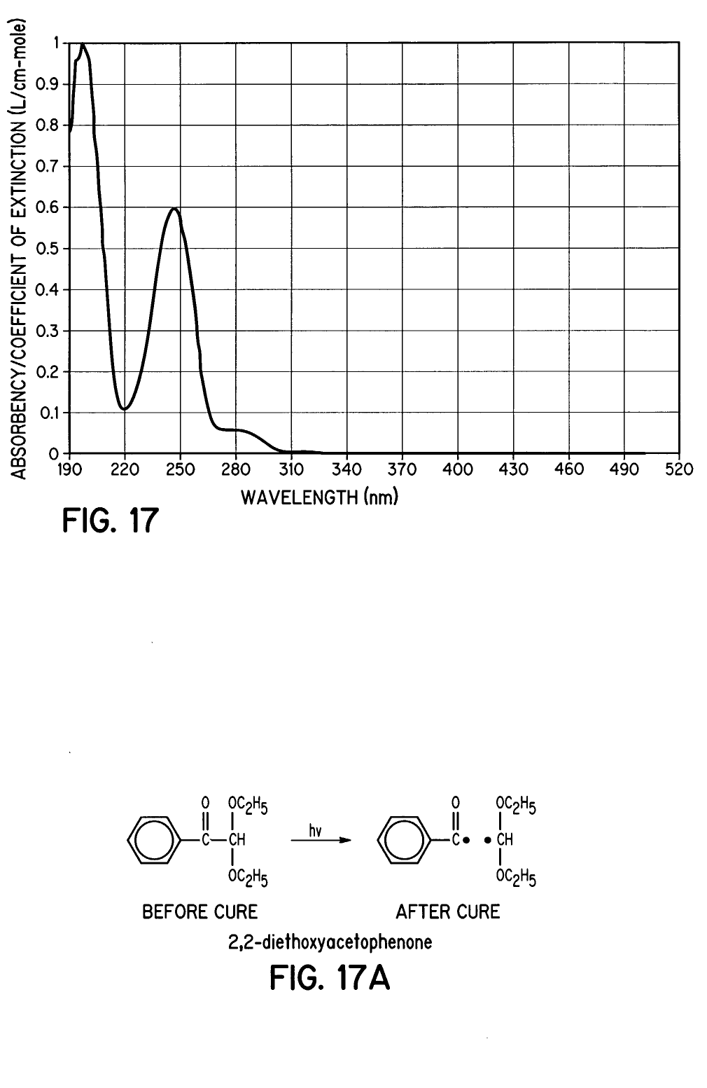

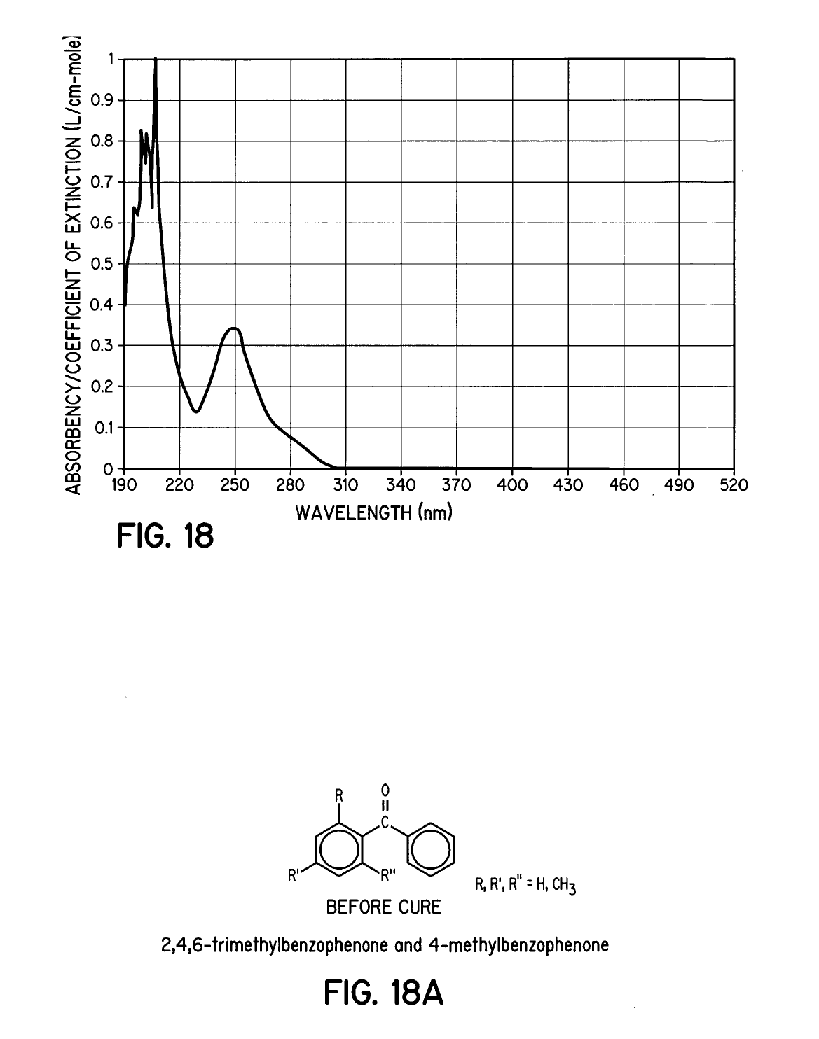

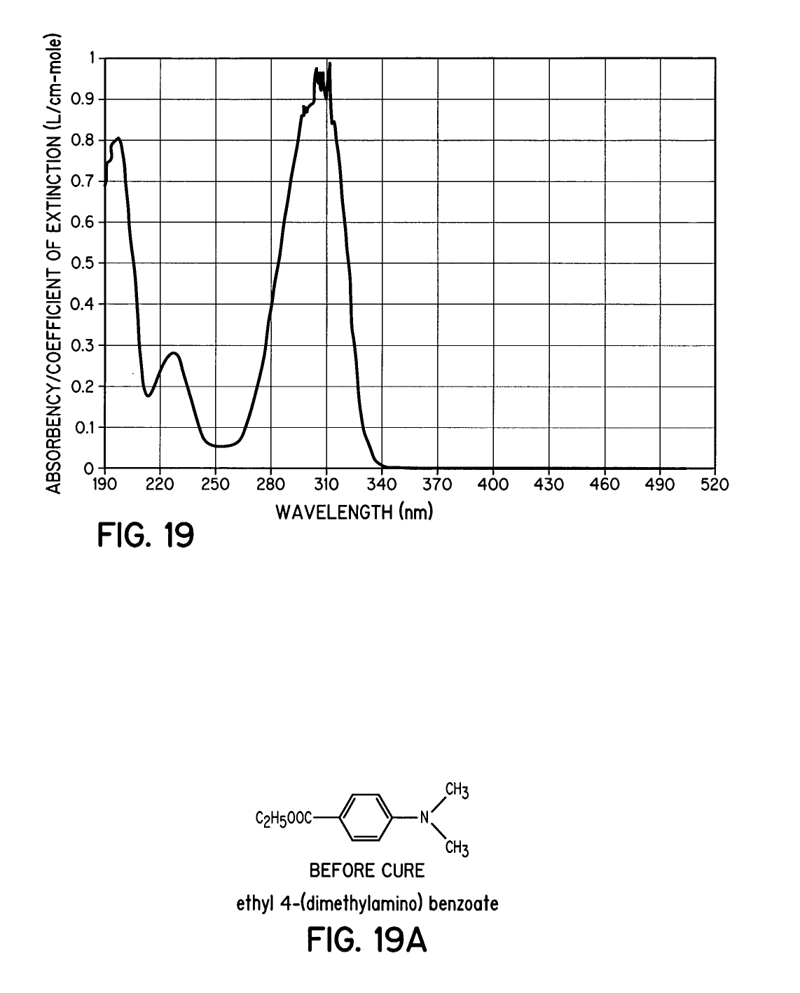

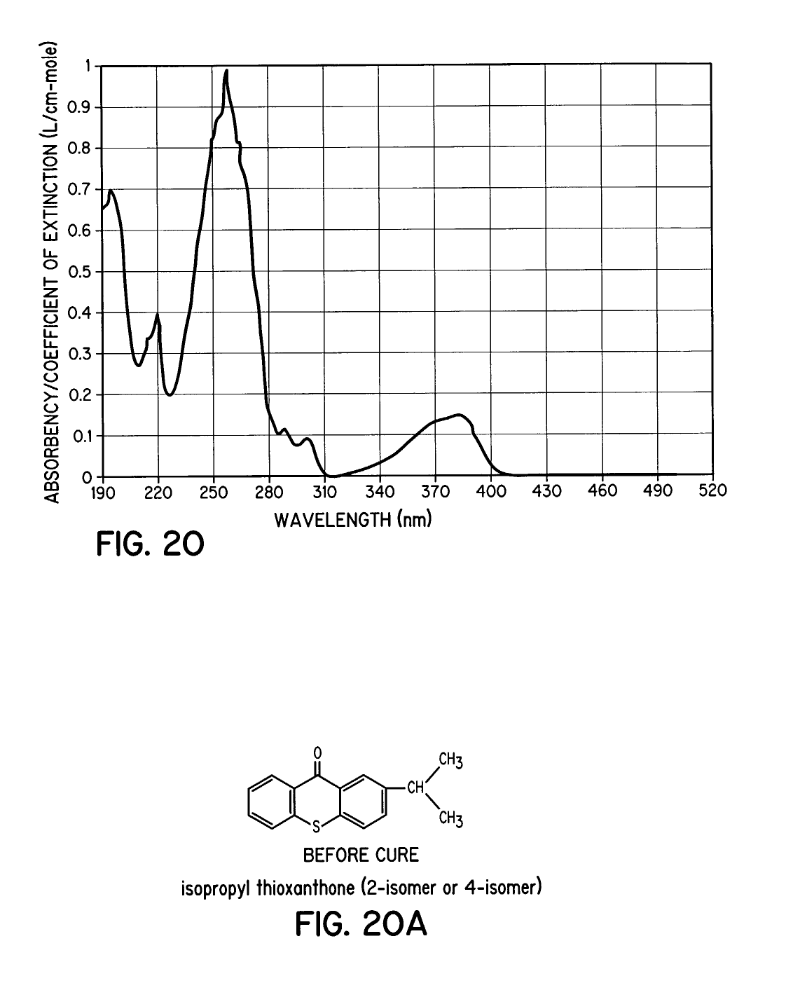

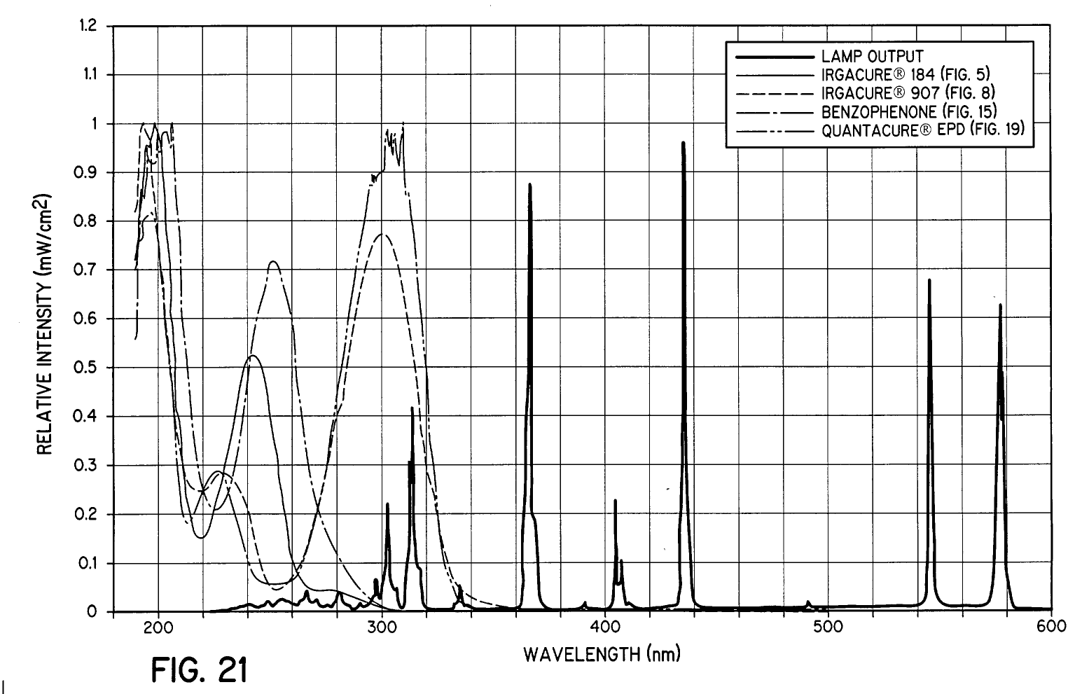

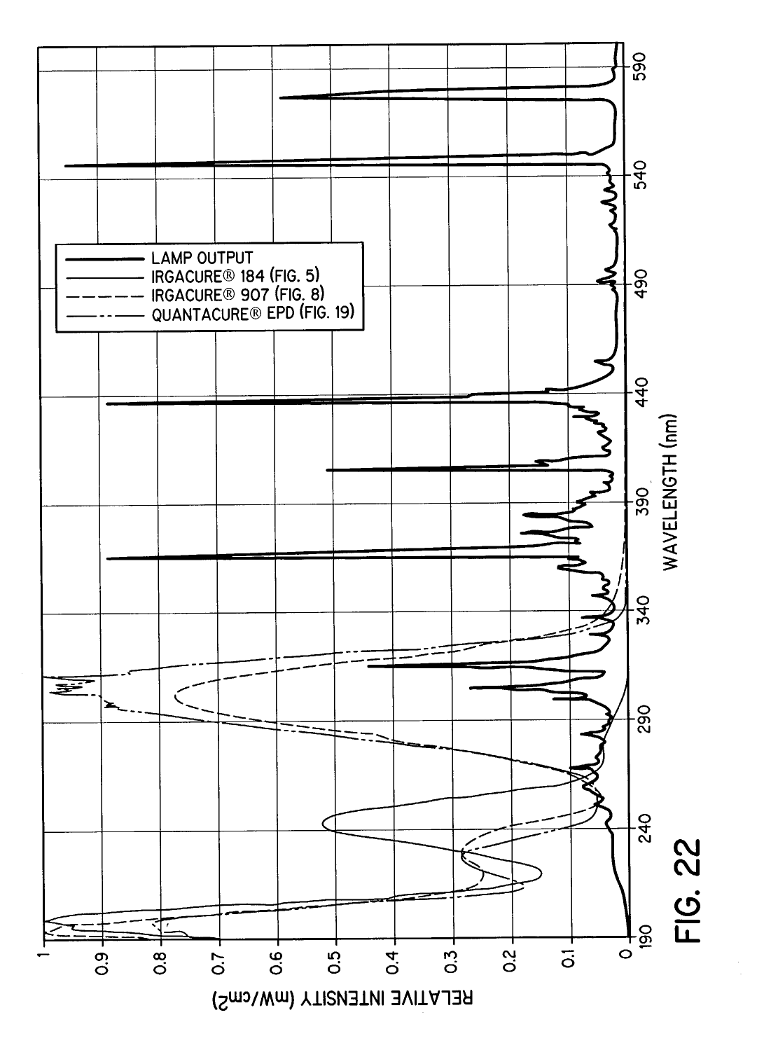

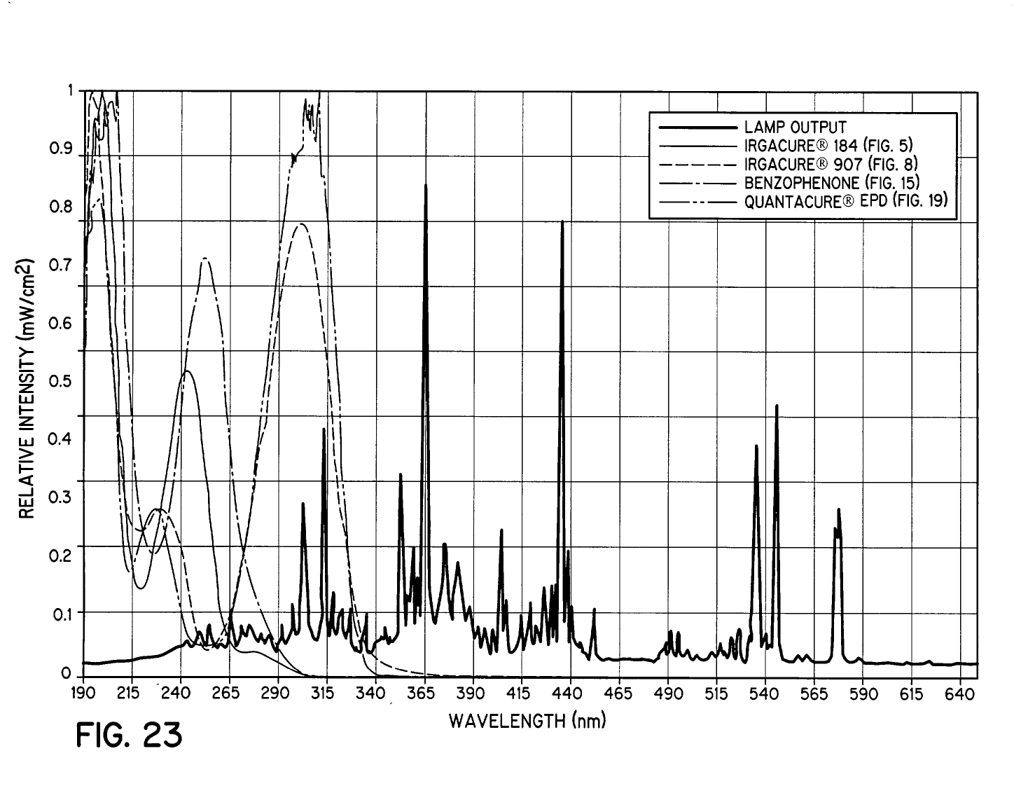

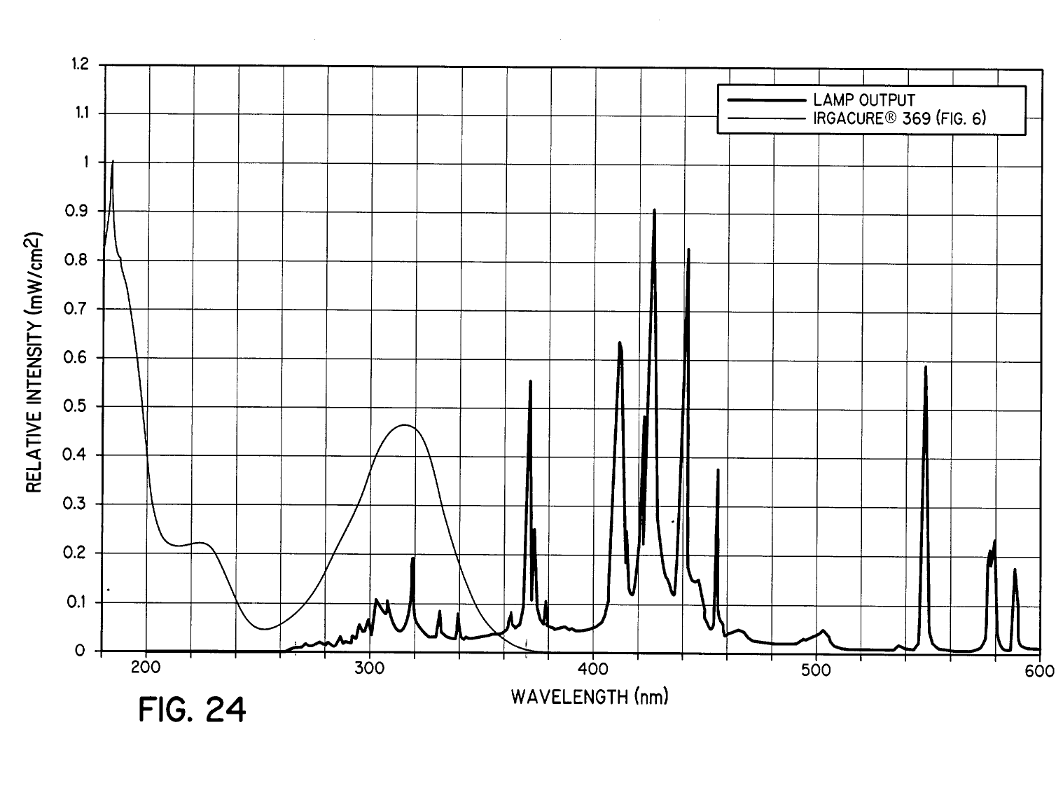

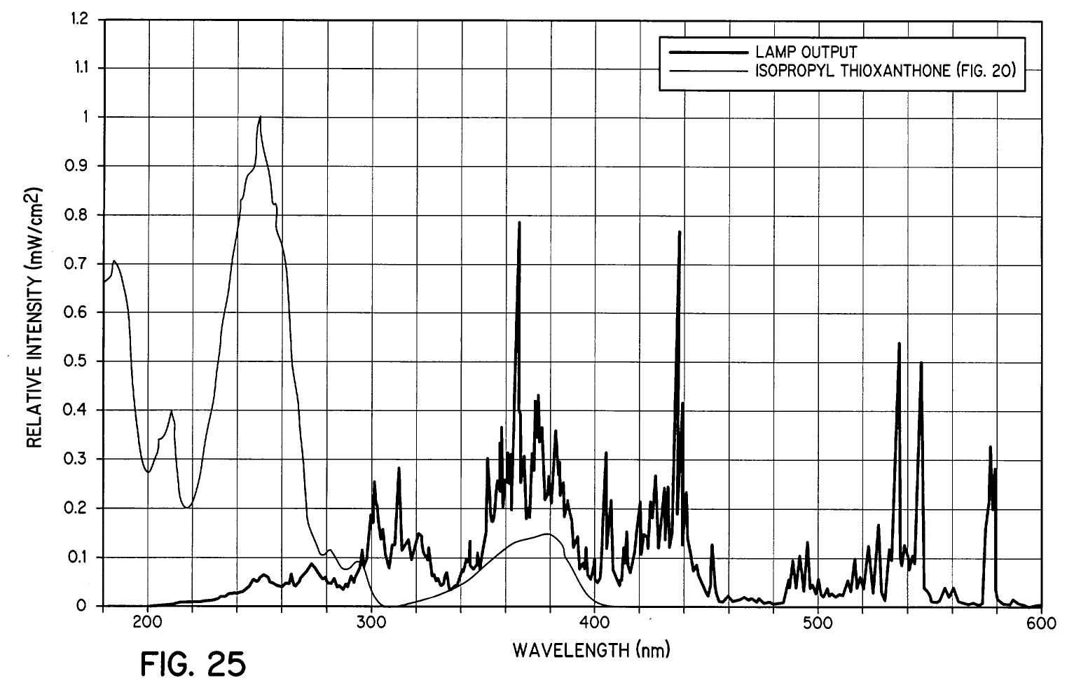

Samples of the absorbency curves for various photoinitiators that may be formulated into commercially available coatings for fiber optic cables are shown in FIGS. 5 through 20. Specifically, these figures each provide the absorbency spectrum for the photoinitiator, which is a plot of wavelength in nanometers on the X axis versus the absorbency or coefficient of extinction in L/cm-mole on the Y axis. Each plot represents the absorbency spectrum for 0.001% by weight photoinitiator in acetonitrile. FIG. 5 depicts the absorbency spectrum for 1-hydroxycyclohexyl phenyl ketone (commercially available as Irgacure® 184). An absorbency peak occurs at about 244 nm, and little absorbency is exhibited at wavelengths above 300 nm. FIG. 5A depicts the chemical structure of this compound both before curing, as shown on the left hand side, and after curing, as shown on the right hand side. FIG. 6 depicts the absorbency spectrum for 2-benzyl-2-N,N-dimethylamino-1-(4-morpholinophenyl)-1-butanone (commercially available as Irgacure® 369). An absorbency peak occurs at about 322 nm, and little absorbency is exhibited at wavelengths above 380 nm. FIG. 6A depicts the chemical structure of this compound, both before and after curing. FIG. 7 depicts the absorbency spectrum for 2,2-dimethoxy-2-phenyl acetophenone (commercially available as Irgacure® 651), and FIG. 7A depicts the chemical structure of this compound, both before and after curing. An absorbency peak occurs at about 250 nm, and little absorbency is exhibited at wavelengths above 305 nm. FIG. 8 depicts the absorbency spectrum for 2-methyl-1-[4-(methylthio) phenyl]-2-morpholino propan-1-one (commercially available as Irgacure® 907), and FIG. 8A depicts the chemical structure of this compound, both before and after curing. An absorbency peak occurs at about 305 nm, and little absorbency is exhibited at wavelengths above 365 nm. FIG. 9 depicts the absorbency spectrum for 2-hydroxy-2-methyl-1-phenyl-propan-1-one (commercially available as Darocur® 1173), and FIG. 9A depicts the chemical structure of this compound, both before and after curing. An absorbency peak occurs at about 244 nm, and little absorbency is exhibited at wavelengths above 300 nm. FIG. 10 depicts the absorbency spectrum for a photoinitiator (commercially available as Irgacure® 1700) that is a mixture of 25% bis(2,6-dimethoxybenzoyl)-2,4,4-trimethylpentyl phosphine oxide and 75% 2-hydroxy-2-methyl-1-phenyl-propan-1-one. An absorbency peak occurs at about 244 nm, a small broad peak occurs at about 285 nm, and little absorbency is exhibited at wavelengths above 370 nm. FIG. 10A depicts the chemical structures of the compounds, both before and after curing. FIG. 11 depicts the absorbency spectrum for a photoinitiator (commercially available as Irgacure® 1800) that is a mixture of 25% bis(2,6-dimethoxybenzoyl)-2,4,4-trimethylpentyl phosphine oxide and 75% 1-hydroxycyclohexyl phenyl ketone. An absorbency peak occurs at about 244 nm, a small broad peak occurs at about 285 nm, and little absorbency is exhibited at wavelengths above 405 nm. FIG. 1A depicts the chemical structures of the compounds, both before and after curing. FIG. 12 depicts the absorbency spectrum for bis(2,4,6-trimethylbenzoyl)-phenylphosphine oxide (commercially available as Irgacure® 819), and FIG. 12A depicts the chemical structure of this compound, before curing. A small broad absorbency peak occurs at about 300 nm, and little absorbency is exhibited at above 405 nm. FIG. 13 depicts the absorbency spectrum for a photoinitiator (commercially available as Irgacure® 1850) that is a mixture of 50% bis(2,6-dimethoxybenzoyl)-2,4,4-trimethylpentyl phosphine oxide and 50% 1-hydroxycyclohexyl phenyl ketone. An absorbency peak occurs at about 244 nm, a small broad peak occurs at about 285 nm, and little absorbency is exhibited at wavelengths above 375 nm. FIG. 13A depicts the chemical structures of the compounds, both before and after curing. FIG. 14 depicts the absorbency spectrum for a photoinitiator (commercially available as Darocur®4265) that is a mixture of 50% 2,4,6-trimethylbenzoyl diphenylphosphine oxide and 50% 2-hydroxy-2-methyl-1-phenyl-propan-1-one, and FIG. 14A depicts the chemical structures of the compounds, both before and after curing. An absorbency peak occurs at about 241 nm, and little absorbency is exhibited at wavelengths above 335 nm. FIG. 15 depicts the absorbency spectrum for benzophenone, and FIG. 15A depicts the chemical structure of this compound, before curing. An absorbency peak occurs at about 250 nm, and little absorbency is exhibited at wavelengths above 300 nm. FIG. 16 depicts the absorbency spectrum for diphenyl (2,4,6-trimethylbenzoyl) phosphine oxide (commercially available as Lucirin® TPO), and FIG. 16A depicts the chemical structure of this compound, both before and after curing. An absorbency peak occurs at about 215 nm, and little absorbency is exhibited at wavelengths above 340 nm. FIG. 17 depicts the absorbency spectrum for 2,2-diethoxyacetophenone (DEAP), and FIG. 17A depicts the chemical structure of this compound, both before and after curing. An absorbency peak occurs at about 250 nm, and little absorbency is exhibited at wavelengths above 305 nm. FIG. 18 depicts the absorbency spectrum for TZT, which is a benzophenone methyl derivative as a mixture of 2,4,6-trimethylbenzophenone and 4-methylbenzophenone. An absorbency peak occurs at about 250 nm, and little absorbency is exhibited at wavelengths above 305 nm. FIG. 18A depicts the chemical structures for the mixture, before curing. FIG. 19 depicts the absorbency spectrum for ethyl 4-(dimethylamino) benzoate (commercially available as Quantacure® EPD), and FIG. 19A depicts the chemical structure before curing. An absorbency peak occurs at about 310 nm, and little absorbency is exhibited at wavelengths above 340 nm. FIG. 20 depicts the absorbency spectrum for both isopropyl-2-thioxanthone and isopropyl-4-thioxanthone, and FIG. 20A depicts the chemical structure before curing. An absorbency peak occurs at about 258 nm, a small broad peak occurs at about 385 nm, and little absorbency is exhibited at wavelengths above 410 nm.

The absorbency curves of the photoinitiators are used to identify one or more wavelength ranges in which the lamp must exhibit intensity output, and to tune and/or adjust the output of the UV curing lamp according to this invention to provide that output. Based on experience known to those skilled in the art, chemicals are added to the lamp, if necessary, to adjust and shift the wavelength output of the lamp and a spectral radiometric test of the lamp is then conducted to determine the actual wavelength output of the modified lamp. The design of the lamp is appropriately adjusted and modified and tested until the wavelength output of the lamp substantially correlates with, or appropriately matches, the absorbency curve of the photoinitiator in the composition to be cured at one or more wavelength ranges. This process may be repeated several times to obtain the spectral radiometric output of the lamp that has the closest match for at least one wavelength range to the absorbency curve of the photoinitiator. A spectral radiometric test is one in which the output energy of the operational lamp is captured and recorded using a spectral radiometer. A curve of the wavelength output of the lamp is plotted on the X axis typically in nanometers (nm) and the intensity is plotted on the Y axis in mill Watts per square centimeter (mW/cm²). By way of example, FIG. 21 provides the spectral radiometric plot of relative intensity versus wavelength for a standard medium pressure mercury arc lamp. FIG. 22 provides a spectral radiometric plot for a modified medium pressure mercury arc lamp in which the intensity output has been increased at the 308 nm peak, in accordance with the present invention. FIG. 23 provides a spectral radiometric plot for a modified medium pressure mercury arc lamp in which the intensity output has been increased at wavelengths below 300 nm, in accordance with the present invention. FIG. 24 provides a spectral radiometric plot for a gallium metal halide additive arc lamp having an industry standard doping level. FIG. 25 provides a spectral radiometric plot for an iron metal halide additive arc lamp having an industry standard doping level.

To cure the UV curable composition on an optical fiber, the lamp must generate ultraviolet light having sufficient intensity at one or more appropriate wavelengths adequate to initiate the polymerization process for the particular photoinitiator present in the UV curable composition. An appropriate wavelength is one corresponding to a wavelength at which the photoinitiator exhibits sufficient absorbency. In accordance with the present invention, a photoinitiator or combination of photoinitiators may be selected so as to have sufficient absorbency at wavelengths corresponding to wavelengths at which the desired lamp has sufficient intensity to initiate polymerization. Alternatively, for a given photoinitiator or combination of photoinitiators, a lamp may be selected so as to have sufficient intensity at wavelengths corresponding to wavelengths at which the photoinitiator(s) has sufficient absorbency to initiate polymerization. Thus, for the method of the present invention, the first step is to identify the wavelengths at which there is absorbency by the photoinitiator and the wavelengths at which there is intensity for the lamp power. Upon such identification, a correlation can then be made between a particular lamp and a particular photoinitiator system to ensure that polymerization is initiated. Such correlation, in accordance with the present invention, may involve matching the right known photoinitiator with the right known lamp; or it may involve developing or selecting a new photoinitiator having the desired absorbency; or it may involve adjusting the intensity output of the lamp, typically by altering the chemical composition of the lamp, such as by increasing or decreasing the quantity of a particular chemical in the composition or by adding a dopant. From a practical standpoint, the optical fiber manufacturer is typically provided with a composition containing a given photoinitiator and so the manufacturer will likely achieve the correlation by selecting an appropriate lamp and adjusting its output, as necessary, to provide sufficient intensity at the desired wavelengths.

Referring to FIG. 21, which is a spectral radiometric plot for a standard mercury arc lamp, the lamp generates ultraviolet light with little output or intensity at wavelengths below 300 nm. Intensity peaks are seen at about 313 nm, about 365 nm and about 405 nm. Several absorbency curves for exemplary photoinitiators of FIGS. 5-20 are overlaid on the plot of FIG. 21 to demonstrate the effectiveness of the standard mercury arc lamp for the exemplary photoinitiators. For Irgacure® 184, for which the absorbency spectrum was depicted in FIG. 5, it is demonstrated that this particular photoinitiator exhibits absorbency at wavelengths below 300 nm, such that the standard mercury arc lamp, without modification, is not likely to adequately initiate polymerization with this photoinitiator. Benzophenone, for which the absorbency spectrum was depicted in FIG. 15, is similar to the Irgacure® 184 in that it exhibits absorbency at wavelengths below 300 nm, and is therefore not likely to sufficiently initiate polymerization by use of a standard mercury arc lamp, which lacks intensity at wavelengths below 300 nm. Thus, the fiber optic manufacturer, in accordance with the present invention, would need to adjust the output of the lamp or select a doped mercury arc lamp for a coating composition comprising an Irgacure® 184 or benzophenone polymerization system. In contrast, the Irgacure® 907 photoinitiator, for which the absorbency spectrum was depicted in FIG. 8, exhibits absorbency in a wavelength range having an absorbency peak at about 305 nm, such that the standard mercury arc lamp will likely initiate polymerization, at least to a certain extent due to the correlation of the lamp output wavelength range peaked at 308 nm with the absorbency range peaked at 305 nm. Quantacure® EPD, for which the absorbency spectrum was depicted in FIG. 19, is similar to the Irgacure® 907 in that it exhibits significant absorbency in a wavelength range peaking at approximately 310 nm, such that polymerization will be initiated, at least to some extent, by the standard mercury arc lamp having a correlative wavelength range with peak intensity at 308 nm. Thus, the fiber optic manufacturer may select the standard mercury arc lamp for coating compositions comprising an Irgacure® 907 or Quantacure® EPD polymerization system.

Referring to FIG. 22, the medium pressure mercury arc lamp was modified in accordance with the present invention to increase the output of the lamp to provide more photons/intensity at wavelengths at and around 308 nm. It may be understood that the intensity effect can be seen not just at the target 308 nm peak wavelength, but for a broad band of wavelengths surrounding the peak. Adjustments may be made by altering the chemical composition within the lamp. With respect to the Irgacure® 184, which exhibits absorbency at wavelengths below 300 nm, a greater amount of lamp output exists at wavelengths below 300 nm by virtue of increasing the output at 308 nm such that the modified mercury arc lamp is sufficient to initiate polymerization with the photoinitiator, at least to a certain extent. With respect to the Irgacure® 907 and Quantacure® EPD photoinitiators, the lamp output is increased at the 308 nm intensity peak substantially corresponding to the 305 nm and 310 nm absorbency peaks for the photoinitiators, respectively, thereby increasing the number of photons at and around those wavelengths to cause the compositions containing the photoinitiators to cure.

Referring to FIG. 23, the medium pressure mercury arc lamp was adjusted, in accordance with the present invention, to increase the intensity output at wavelengths below 300 nm. For all of the photoinitiators, including the Irgacure® 184, Irgacure® 907, benzophenone and Quantacure® EPD for which the absorbency curves are overlaid onto the lamp output plot, the intensity increase at wavelengths below 300 nm provides photons in a wavelength band or range substantially corresponding to wavelengths of the photoinitiators that exhibit absorbency, thereby enabling the photoinitiator to initiate the polymerization process.

Referring to FIG. 24, the output power for a mercury arc lamp doped with gallium is depicted. The standard gallium doping has the effect of shifting the high intensity output to higher wavelengths, but also generally increases the intensity in non-peak wavelength regions. Irgacure® 369, the spectrum for which was depicted in FIG. 6, has a peak at about 322 nm and exhibits some absorbency up to about 380 nm. Thus, polymerization will be initiated to a certain extent by photons generated at and around that peak wavelength and up to about 380 nm. In accordance with the present invention, the lamp output may be further increased by intentionally increasing the photons at and around the 320 nm peak of the lamp output to further increase the correlation between the lamp output and the absorbency of the photoinitiator.

Referring to FIG. 25, the intensity output for a mercury arc lamp doped with iron is provided. The industry standard amount of iron dopant has the effect of shifting the intensity to provide a large number of low intensity peaks over a broad range of wavelengths. The absorbency spectrum for isopropyl-thioxanthone, which was depicted in FIG. 20, is overlaid to show that this particular photoinitiator contains a small broad peak at a wavelength of about 385 nm, with an absorbency of 0.1 or greater at wavelengths ranging from about 360 nm to about 395 nm, which substantially corresponds to a high intensity region from about 350 nm to about 395 nm for the iron metal halide arc lamp. Thus, the iron metal halide lamp has an output substantially correlated to one of the absorbency peaks of the isopropyl-thioxanthone photoinitiator to thereby enable initiation of polymerization of a composition containing that photoinitiator. Further correlation may be obtained by adjusting the output of the lamp to further increase the number of photons at and around the 385 nm peak.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

We claim:

1. A system for curing a UV curable composition on an optical fiber comprising:
an elongate tube adapted to have the optical fiber having an uncured composition applied thereto drawn therethrough, the uncured composition comprising at least one photoinitiator having an absorbency wavelength; and
a pair of medium pressure arc lamps positioned on diametrically opposite sides of the tube, wherein each of the lamps has a light wavelength output that substantially correlates with the absorbency wavelength of the photoinitiator;
a pair of reflectors positioned around the respective pair of arc lamps; and
a stepless power supply operably coupled to each of the arc lamps,
wherein the power supply drives the lamps to generate ultraviolet light which is directed through the tube onto the uncured composition of the optical fiber being drawn through the tube to thereby cure the composition.

2. The system of claim 1 wherein the tube is a quartz tube.

3. The system of claim 1 wherein the composition is a coating formulation for coating a core and cladding of the optical fiber.

4. The system of claim 1 wherein the composition is an ink for coloring the optical fiber.

5. The system of claim 1 wherein the composition is an adhesive for binding together a plurality of optical fibers to form a fiber cable.

6. The system of claim 1 wherein the photoinitiator comprises at least one compound selected from the group consisting of: 1-hydroxycyclohexyl phenyl ketone; 2-benzyl-2-N,N-dimethylamino-1-(4-morpholinophenyl)-1-butanone; 2,2-dimethoxy-2-phenyl acetophenone; 2-methyl-1-[4-(methylthio)phenyl]-2-morpholino propan-1-one; 2-hydroxy-2-methyl-1-phenyl-propan-1-one; bis(2,6-dimethoxybenzoyl)-2,4,4-trimethylpentyl phosphine oxide; bis(2,4,6-trimethylbenzoyl)phenylphosphine oxide; 2,4,6-trimethylbenzoyl diphenylphosphine oxide; benzophenone; 2,2-diethoxyacetophenone; 2,4,6-trimethylbenzophenone; 4-methylbenzophenone; ethyl 4-(dimethylamino) benzoate; isopropyl-2-thioxanthone; and isopropyl-4-thioxanthone.

7. The system of claim 1 wherein the arc lamps are medium pressure mercury arc lamps.

8. The system of claim 1 wherein the arc lamps are medium pressure gallium metal halide additive arc lamps.

9. The system of claim 1 wherein the arc lamps are medium pressure iron metal halide additive arc lamps.

10. The system of claim 1 wherein the tube and the arc lamps are mounted vertically.

11. The system of claim 1 wherein the tube and the arc lamps are mounted horizontally.

12. The system of claim 1 wherein the reflectors are focused elliptical reflectors.

13. The system of claim 1 wherein the light is at least partially reflected from the reflectors through the tube.

14. The system of claim 1 wherein each of the lamps contains a chemical dopant that increases the light wavelength output of the lamps to substantially correlate with the absorbency wavelength of the photoinitiator.

15. A system for curing a composition on an optical fiber comprising:
an elongate quartz tube adapted to have the optical fiber having an uncured composition applied thereto drawn therethrough, the uncured composition comprising at least one photoinitiator having an absorbency wavelength;
a pair of medium pressure arc lamps positioned on diametrically opposite sides of the quartz tube, the arc lamps being selected from the group consisting of medium pressure mercury arc lamps, medium pressure gallium metal halide additive arc lamps, and medium pressure iron metal halide additive arc lamps, wherein each of the lamps has a light wavelength output that substantially correlates with the absorbency wavelength of the photoinitiator;
a pair of focused elliptical reflectors each positioned around one of the arc lamps to focus and direct ultraviolet light emitted from the lamps toward the quartz tube and optical fiber being drawn there through; and
a stepless power supply operably coupled to each of the arc lamps to thereby generate ultraviolet light from the lamps which is directed through the quartz tube both directly and reflected from the reflectors onto the composition of the optical fiber being drawn through the quartz tube to thereby cure the composition.

16. The system of claim 15 wherein the composition is a coating formulation for coating a core and cladding of the optical fiber.

17. The system of claim 15 wherein the composition is an ink for coloring the optical fiber.

18. The system of claim 15 wherein the composition is an adhesive for binding together a plurality of optical fibers to form a fiber cable.

19. The system of claim 15 wherein the photoinitiator comprises at least one compound selected from the group consisting of: 1-hydroxycyclohexyl phenyl ketone; 2-benzyl-2-N,N-dimethylamino-1-(4-morpholinophenyl)-1-butanone; 2,2-dimethoxy-2-phenyl acetophenone; 2-methyl-1-[4-(methylthio)phenyl]-2-morpholino propan-1-one; 2-hydroxy-2-methyl-1-phenyl-propan-1-one; bis(2,6-dimethoxybenzoyl)-2,4,4-trimethylpentyl phosphine oxide; bis(2,4,6-trimethylbenzoyl)phenylphosphine oxide; 2,4,6-trimethylbenzoyl diphenylphosphine oxide; benzophenone; 2,2-diethoxyacetophenone; 2,4,6-trimethylbenzophenone; 4-methylbenzophenone; ethyl 4-(dimethylamino) benzoate; isopropyl-2-thioxanthone; and isopropyl-4-thioxanthone.

20. The system of claim 15 wherein the tube and the arc lamps are mounted vertically.

21. The system of claim 15 wherein the tube and the arc lamps are mounted horizontally.

22. A method for curing a composition on an optical fiber comprising:
selecting a photoinitiator having an absorbency wavelength;
selecting a pair of medium pressure arc lamps having a light wavelength output, wherein selecting the photoinitiator and lamps includes substantially correlating the absorbency wavelength and the light wavelength output;
applying a UV-curable, uncured composition containing the photoinitiator to the optical fiber;
drawing the optical fiber having the uncured composition thereon through an elongate tube positioned in a UV curing cassette, the cassette including the pair of medium pressure arc lamps positioned on diametrically opposite sides of the optical fiber, a pair of reflectors positioned around the respective pair of arc lamps, and a stepless power supply operably coupled to each of the arc lamps;
driving the lamps with the power supply to generate ultraviolet light having the light wavelength output that substantially correlates with the absorbency wavelength of the photoinitiator; and
directing the light through the tube onto the composition of the optical fiber being drawn through the tube to thereby cure the composition.

23. The method of claim 22 wherein applying the composition includes coating a core and cladding of the optical fiber.

24. The method of claim 22 wherein applying the composition includes applying an ink onto the optical fiber for coloring the optical fiber.

25. The method of claim 22 further comprising bundling together a plurality of optical fibers prior to applying the composition, wherein the composition is an adhesive applied for binding the plurality of optical fibers together to form a fiber cable.

26. The method of claim 22 wherein the photoinitiator comprises at least one compound selected from the group consisting of: 1-hydroxycyclohexyl phenyl ketone; 2-benzyl-2-N,N-dimethylamino-1-(4-morpholinophenyl)-1-butanone; 2,2-dimethoxy-2-phenyl acetophenone; 2-methyl-1-[4-(methylthio)phenyl]-2-morpholino propan-1-one; 2-hydroxy-2-methyl-1-phenyl-propan-1-one; bis(2,6-dimethoxybenzoyl)-2,4,4-trimethylpentyl phosphine oxide; bis(2,4,6-trimethylbenzoyl) phenylphosphine oxide; 2,4,6-trimethylbenzoyl diphenylphosphine oxide; benzophenone; 2,2-diethoxyacetophenone; 2,4,6-trimethylbenzophenone; 4-methylbenzophenone; ethyl 4-(dimethylamino) benzoate; isopropyl-2-thioxanthone; and isopropyl-4-thioxanthone.

27. The method of claim 22 wherein the arc lamps are medium pressure mercury arc lamps.

28. The method of claim 22 wherein the arc lamps are medium pressure gallium metal halide additive arc lamps.

29. The method of claim 22 wherein the arc lamps are medium pressure iron metal halide additive arc lamps.

30. The method of claim 22 wherein the reflectors are focused elliptical reflectors.

31. The method of claim 22 wherein the light is at least partially reflected from the reflectors through the tube.

32. The method of claim 22 wherein drawing the optical fiber through the tube is at a rate of about 1000-2000 m/min.

33. The method of claim 32 wherein the power supply drives the arc lamps at a power of about 300 to about 700 WPI.

34. The method of claim 22 wherein drawing the coated optical fiber through the tube is at a rate of about 1000-1500 m/min.

35. The method of claim 22 wherein the power supply drives the arc lamps at a power of about 300 to about 700 WPI.

36. The method of claim 22 wherein the applying, drawing and driving are performed a first time and then a second time, the first time comprising applying a primary soft coating composition for providing flexibility to the fiber, the second time comprising applying a secondary hard coating composition for providing abrasion resistance to the fiber.

37. The method of claim 22 wherein selecting the lamps includes modifying the chemical composition of the lamps to adjust the light wavelength output to substantially correlate with the absorbency wavelength of the photoinitiator.

38. The method of claim 37 wherein modifying the chemical composition includes adding a dopant.
